(19) United States
(12) Patent Application Publication
(10) Pub. No.: US 2018/0034159 A1
(43) Pub. Date: Feb. 1, 2018

(54) CAVITY BACKED SLOT ANTENNA

(71) Applicant: Kabushiki Kaisha Toshiba, Minato-ku (JP)

(72) Inventor: Sema DUMANLI OKTAR, Bristol (GB)

(73) Assignee: Kabushiki Kaisha Toshiba, Minato-ku (JP)

(21) Appl. No.: 15/551,073

(22) PCT Filed: Nov. 2, 2015
(86) PCT No.: PCT/GB2015/053296

§ 371 Date: Aug. 15, 2017

(51) Int. Cl. H01Q 13/18; H01Q 1/38; H01Q 1/27

(52) U.S. Cl. CPC H01Q 13/18; H01Q 1/273; H01Q 1/38

(57) ABSTRACT

A cavity backed slot antenna that comprises at least two internal volume defining walls that define an internal volume and at least two further walls that are located opposite to the internal volume defining walls across the cavity and that project into the internal volume so that an outer surface created by the at least two further walls is located such that at least part of the internal volume is at an outside of the outer walls. At least two internal volume defining walls comprise a resonant slot.

### FIELD

Embodiments described herein relate generally to antenna, in particular cavity backed slot antennae.

### BACKGROUND

Conventionally a slot is etched onto one or more faces of a rectangular or a cylindrical metallic cavity in order to form a cavity backed slot. Arrangements in which multiple half wavelength slots are individually etched onto multiple faces of a cuboid cavity and activated or deactivated in order to reconfigure a radiation pattern that can be created using the cavity are known. In another case a slot with a length in the order of multiple wavelengths is etched onto multiple faces of a cuboid to reconfigure the radiation pattern generated by the cavity.

### BRIEF DESCRIPTION OF THE DRAWINGS

In the following, embodiments will be described with reference to the drawings in which:

FIG. 1 shows an embodiment of a 3D slot backed with a cornered shallow cavity;

FIG. 2 shows an embodiment of a 3D cavity backed slot located on the edge of a hip stem;

FIG. 3 shows a simulation of an antenna according to an embodiment located inside a human body phantom;

FIG. 4 shows the simulated input reflection loss |s11| in dB vs Freq in GHz for an antenna according to an embodiment; and

FIG. 5 shows a prototyped antenna without radome.

### DETAILED DESCRIPTION

According to an embodiment there is provided a shallow non-planar cavity antenna comprising a resonant slot. Non-planar preferably mean that the cavity is conformal (to an underlying structure). Preferably the cavity forming walls that are to abut another structure, that is some or all of the walls that do not carry resonant slots, are conformal.

The slot may extend in at least two planes.

The cavity may be formed by two nested convex walls, wherein the slot extends across a wall of the at least two walls that forms a convex outer wall of the cavity.

Each of two nested convex walls can be formed of two or three planar walls.

According to an embodiment there is provided a cavity backed slot antenna comprising at least two internal volume defining walls that define an internal volume and at least two further walls that are located opposite to the internal volume defining walls across the cavity and that project into the internal volume so that an outer surface created by the at least two further walls is located such that at least part of the internal volume is at an outside of the outer walls. The at least two internal volume defining walls comprise a resonant slot.

The at least two internal volume defining walls may form a convex arrangement and the at least two further walls may form a concave arrangement nested within the convex arrangement.

According to an embodiment there is provided a shallow cavity antenna comprising a resonant slot that extends over at least two faces of the cavity.

The resonant slot may be a half-wavelength slot.

The slot may comprise an elongated section with one or more closed ended slots extending from one or both sides thereof.

The slot may comprise a first slot resonant at a first frequency and a second slot resonant at a second frequency, wherein the first and second frequencies are different.

The first and second frequencies can have bandwidth that overlap so that the input reflection loss of the antenna between the two frequencies does not rise above −10 dB.

The antenna can be shaped to accommodate a corner or an edge of an underlying structure, such as an implant.

According to an embodiment there is provided an implant for use in a human or animal body comprising any of the above described antennae.

According to an embodiment there is provided a non-transient data storage device storing information for use by a 3D printer, the information, when used by the 3D printer causing the 3D printer to print any of the above described antennae.

The information may define the geometry of the antenna.

The information may comprise commands for execution by the 3D printer, wherein said commands, when executed, cause the 3D printer to print the antenna.

According to an embodiment there is provided a method of forming a cavity backed slot antenna comprising defining an internal volume by providing at least two internal volume defining walls, providing, within the internal volume at least two further walls that are located opposite to the respective internal volume defining walls across the cavity and that project into the internal volume so that an outer surface created by the at least two further walls is located such that at least part of the internal volume is at an outside of the outer walls and providing a resonant slot in the at least two internal volume defining walls comprise a resonant slot.

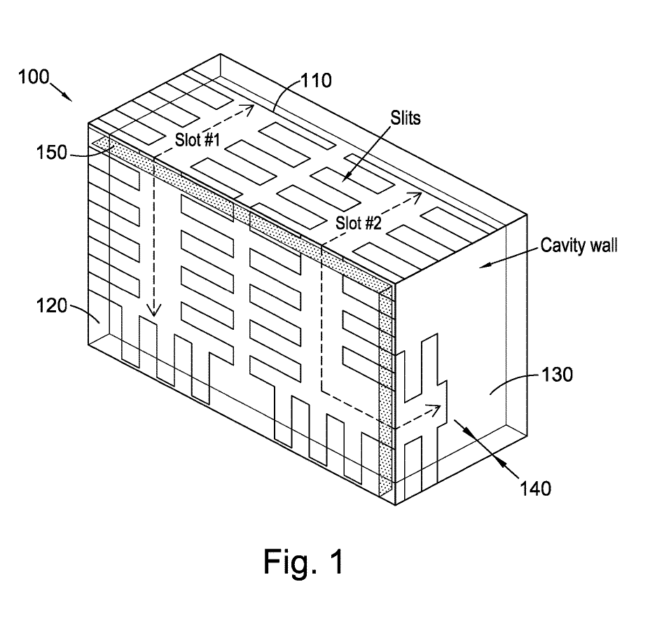

FIG. 1 shows a cavity 100 of an embodiment. The cavity 100 consists of three conductive walls 110, 120 and 130. The three walls are conductively connected with each other. Three further conductive walls are provided. These three further walls extend parallel to the walls 110, 120 and 130 respectively at a distance 140. Whilst this distance 140 is only indicated for the wall parallel to wall 130 in FIG. 1 the walls parallel to wall 110 and 120 are equally spaced apart from walls 110 and 120 in this manner. All of these walls are conductively connected to their respective neighbours where the walls abut each other as well as across all spacing distances 140. Whilst in this embodiment the walls 110, 120 and 130 are all spaced apart from the walls extending parallel to them by the same distance 140 it will be appreciated that this is not essential and that, instead the spacing between the respective sets of parallel walls can differ for different wall pairs.

It will be appreciated that the antenna 100 shown in FIG. 1, whilst forming a cavity by virtue of the conductive interconnections between the walls, does not form a cuboid cavity. Whilst the walls 110, 120 and 130 of the shallow cavity 100 of the embodiment define an interior space much in the same way as they would if they formed part of a cuboid cavity, at least a part of this interior space remains outside of the cavity. This is because the walls located parallel to walls 110, 120 and 130 form a corner that projects inwardly towards the corner formed by walls 110, 120 and 130. The interior space defined by walls 110, 120 and 130 is consequently only partially occupied by components of the cavity 100, namely by the walls that extend in parallel to walls 110, 120 and 130 and by any dielectric material between all of the walls/that supports the walls. The cavity can consequently be made conformal, and may be placed over an existing structure, say for example over the edge of an existing structure, so that it occupies only a small amount of space. Cavity antennas of the type described herein consequently provide advantages in terms of miniaturisation for use in environments with limited availability of space. The shape of the cavity moreover allows for some space for material to isolate the resonant slots from underlying structures to which the field generated by the resonant slots may electrically couple. When referring to a shallow cavity in the present disclosure reference is made to a cavity that has a spacing 150 between opposing cavity walls that is less than 1/10 of the wavelength of the central resonant frequency of the cavity. All internal dimensions of the cavity are such that any resonant mode supported by the cavity has a frequency that is above the resonance frequency of the slots. Consequently any resonance the cavity may be able to support will not interfere with the resonance behaviour of the slots and will not be excited by excitation of the resonance frequencies supported by the slots.

The cavity 100 moreover comprises two resonant (half wavelength) slots, marked as Slot#1 and Slot#2 in FIG. 1. These slots are provided on the side walls 110, 120 and 130 in a known fashion and can be formed, for example, by etching them into the conductive side walls. Both of these slots extend across more than one of the side walls 110, 120 and 130 of the cavity. By allowing the slots to occupy more than one side wall, individual side walls no longer have to be of a size that is suitable for holding a resonant slot. Consequently, by allowing a resonant slot to extend over more than one side wall, the cavity can be miniaturised further whilst still providing a resonant slot. As can be seen from FIG. 1 the electrical length of the slots is moreover increased by providing slits that extend to either sides of the slots, thereby further reducing the amount of space the slot requires to occupy in a given direction. It will be appreciated that the placement and dimensions of the slits as well as the slot can be chosen such as to optimise the amount of space they occupy whilst keeping to a required frequency and bandwidth specification. The slit width and slit length can, in particular, be tuned together with the slot length and with itself to adjust the operating frequencies/bandwidths of the individual slots and therefore also the bandwidth of the antenna. The radiative field generated by the antenna can be shaped by choosing the location of the slots on the walls 110, 120 and 130. The location of the slots is not as critical for the pattern of the radiative field generated by the antenna of the embodiment as is the case for other, known cavity antennas. If the walls that extend in parallel to the walls 110, 120 and 130 are continuous conductive surfaces they electrically isolate the antenna from underlying structures to which it conforms.

In the embodiment the length of the first slot is between 0.45 and 0.55 wavelength before it is loaded with slits. After the loading, depending on the slit width and length, the slot length decreases. The recommended slit length is the same as the slot width and the slit width is chosen to be ⅙th of the slit length. The length of the second slot is chosen to be 20% longer than the first slot. This creates a larger bandwidth.

The cavity 100 is excited by means of a suspended stripline feed 150 that is sandwiched between the parallel walls and shortened to one of the conductive faces connecting the opposing walls. The stripline feed 150 is suspended as, whilst extending in close proximity to walls 110, 120 and 130, it is spaced apart from any other conducting surface further than from walls 110, 120 and/or 130 respectively. This is because, as the side of the stripline feed 150 that is opposite to the walls 110, 120 and 130 respectively, the dielectric that separates the walls 110, 120 and 130 from their opposing counterpart walls is present, so that the distance between the stripline feed 150 and the next closest conductive structure is larger than the distance separating the stripline feed 150 from the walls 110, 120 and 130. It will of course be appreciated that the respective distances between the stripline feed 150 and the walls 110, 120 and 130 can be but does not have to be the same.

The length and position of the feed is adjusted so that a desired/50Ω input impedance match is achieved, although the stripline if offset from a central position of the slot. The stripline can also be meandered for miniaturisation purposes and/or for exciting multiple slots. Whilst FIG. 1 illustrates a cavity with two slots it will be appreciated that a different number of slots, such as single slot or more than two slots can be provided. By choosing more than one slot of different electrical length different resonances are created, increasing the bandwidth of the antenna. This is useful in applications in which the antenna is located close to conductive material that can cause a certain amount of de-tuning of the antenna. This is, for example, the case for implantable antennae that are almost inevitably close to conducting tissue. The stripline feed extends over the slots in a position and having a length/respective end points so that the impedance match is achieved at all of the resonance frequencies of the cavity/slot combination. A desired position of the stripline feed 150 is determined through simulation.

In one embodiment the antenna is used for communication of information from an implant in the human body. In this embodiment the antenna is surrounded by a radome (superstrate) for isolation from conductive structures in the body. Part of the near field generated by the antenna can be contained in the radome, so that near field losses are at least reduced. The high magnetic near fields are less susceptible to dissipation in human body than the electric near field of an electric antenna such as a dipole. Therefore a slot is more advantageous than a commonly used 3D PIFA for implants. In the embodiment the substrate is chosen to be a substrate with high dielectric constant of 6.15. The radome is of the same material with the same thickness of 1.27 mm.

Whilst the further walls discussed above extend parallel to walls 110, 120 and 130 it will be appreciated that it is not essential that a walls insulating a resonant slot from an underlying or surrounding structure needs to extend parallel to a wall comprising the slot.

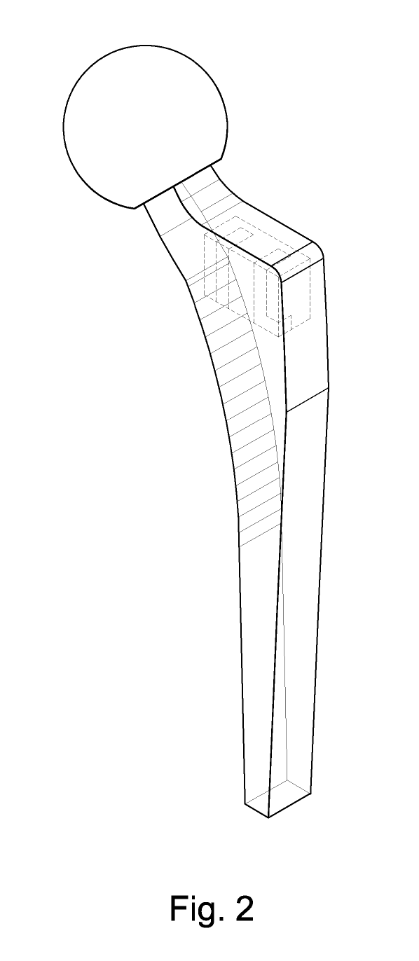

FIG. 2 shows the shallow cavity antenna shown in FIG. 1 placed on a corner of a hip implant. It will be appreciated that the space requirement of the antenna only marginally increases the overall space requirement of the implant in the human body. It will be appreciated that, as the orthopaedic implant's surface is conductive, the stem itself can be used as a large ground plane. In this configuration the cavity walls that do not comprise a slot can be replaced by the surface of the implant.

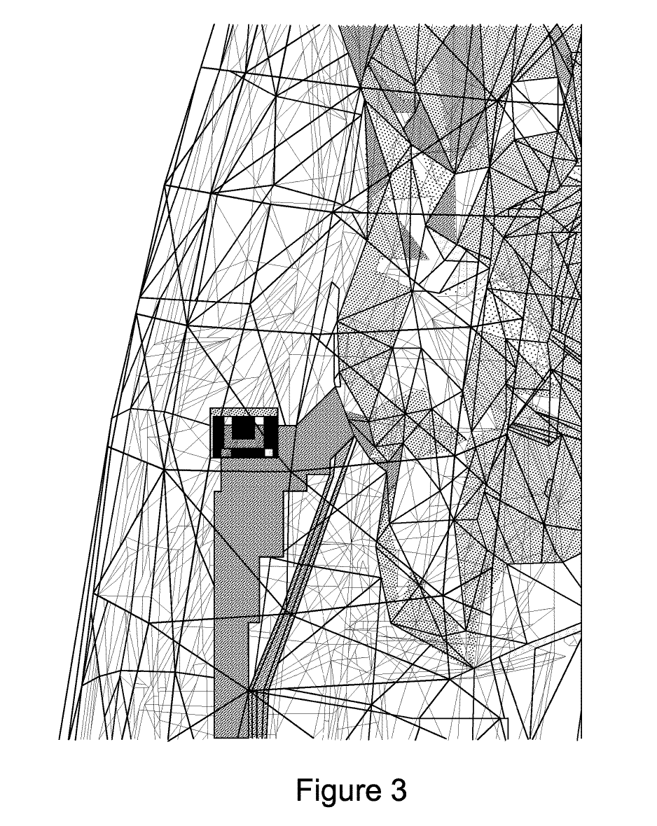

FIG. 3 shows a model for the simulation of electromagnetic fields of the antenna of FIG. 1 whilst located on a hip implant in the manner shown in FIG. 2 and surrounded by the relevant parts of human anatomy.

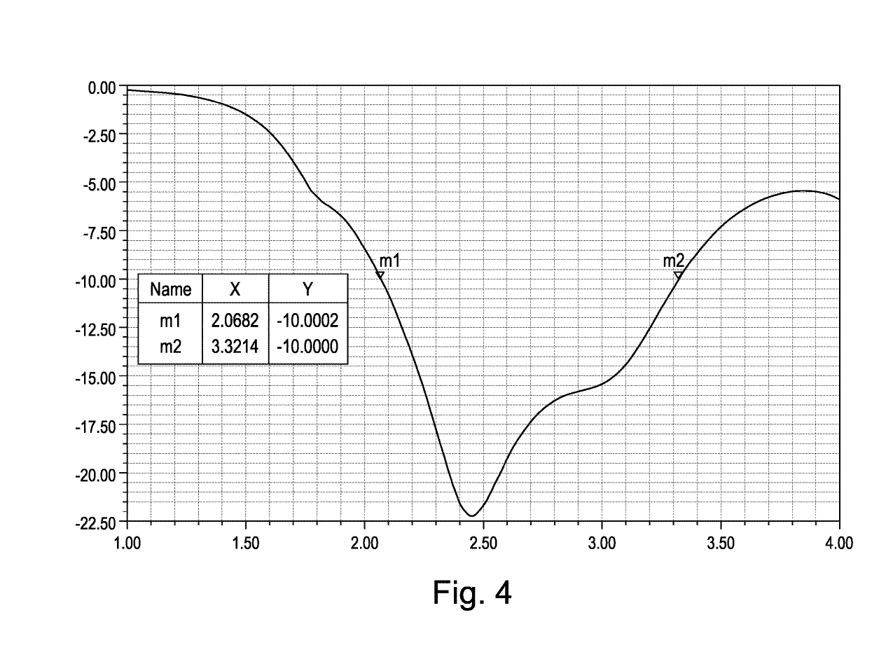

FIG. 4 shows the simulated input reflection loss |s11| in dB vs Freq in GHz for the antenna in this configuration. Because of the presence of the two slots a wide −10 dB bandwidth of −1.25 GHz is achieved. The two resonances due to the slots are visible at 2.5 GHz and 3 GHz. The cornered cavity can be made larger by adding one or more additional extending it at another planes and a larger slot which can excite 403 MHz MICS band can be included.

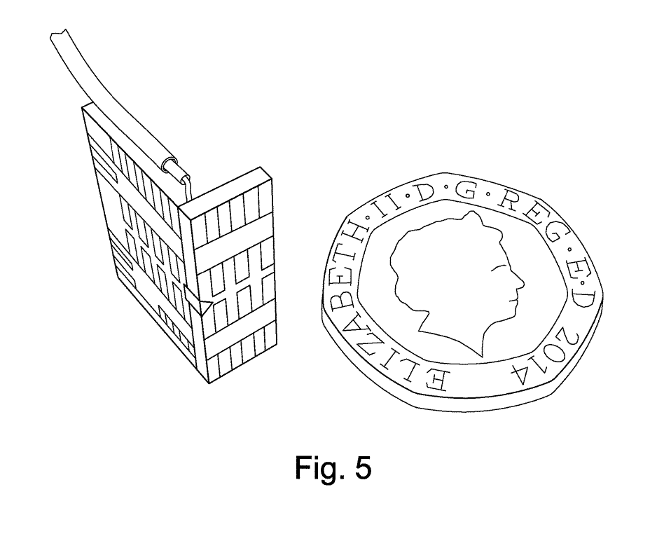

FIG. 5 shows a prototype of the antenna shown in FIG. 1 but excluding the radome.

Whilst the above described embodiments related to shallow “corner” cavity that had walls that are much larger in both directions than the spacing (140 in FIG. 1) between opposing walls it will be appreciated that, in other embodiments a shallow “edge” cavity may instead be provided, i.e. a cavity that omits one of the walls 110, 120 or 130 as well as the associated cavity wall that extends in parallel to the omitted surface and the dielectric sandwiched between the two omitted walls. It is, in another embodiment, equally envisaged that, instead of removing one of walls 110, 120, 130, the wall parallel to it and the dielectric sandwiched between the two walls, a similar wall/dielectric/wall configuration is added in parallel to one or two of walls 110, 120, 130 at one of the free edges of walls 120, 110 or 130 respectively. In so doing a four or five sided shallow cavity structure that still allows full access to the space enclosed by it via two or three sides respectively is created. By providing a larger number of outer walls more degrees of freedom for placement of the meandering slots are provided. This is useful in either lowering the resonance frequencies of the slot (by making the slots longer) or decreasing the size of the space enclosed by the cavity antenna, given that a slot of a pre-defined desired length can be placed on a large number of surface. These surfaces can consequently be reduced in size.

Whilst the above described embodiments are discussed as comprising planar side walls it is also envisaged that the corner or edge cavities can be created by using flexible substrates coated with conductive surfaces and etched to comprise a desired slot pattern. Such flexible substrates may be bent for conformity with and underlying structure and a thus formed cavity resonator may not comprise edges between planes in which the cavity walls extend. Instead a smooth transition between the cavity walls may be provided. Alternatively a curved substrate (which may be provided to be in conformity with a predetermined underlying structure, such as a medical implant) maybe provided and its surfaces may be rendered conductive. This can be achieved by printing on the surfaces using conductive printing materials/ink. The slots can be formed by simply not printing on the relevant areas or by removing conductive matter from these areas after printing has finished.

Whilst in the above discussed methods entire walls of the cavity are formed in a single or a small number of production steps, advances in 3D printing technology have made it possible to print electronic circuitry. It is thus further envisaged that some or all of the walls of the cavity can be built up in very small incremental steps, layer by layer if the direction of printing is not parallel to the surface. Using 3D printing techniques antennae of embodiments maybe made maximally conformal with underlying structures. It is moreover envisaged that, if a device to which the cavity antenna is required to conform is itself printed using a 3D printer, then the cavity antenna may be printed in the same printing process as the device. This may, for example, be practice in the case of medical implants that are printed for optimum conformity with the human body and that may have a cavity antenna of the herein described type added in the same printing process.

Whilst certain embodiments have been described, these embodiments have been presented by way of example only, and are not intended to limit the scope of the inventions. Indeed, the novel devices, and methods described herein may be embodied in a variety of other forms; furthermore, various omissions, substitutions and changes in the form of the devices, methods and products described herein may be made without departing from the spirit of the inventions. The accompanying claims and their equivalents are intended to cover such forms or modifications as would fall within the scope and spirit of the inventions.

1. A shallow non-planar cavity antenna comprising a resonant slot.

2. An antenna according to claim 1, wherein the slot extends in at least two planes.

3. An antenna as claimed in claim 2, wherein the cavity is formed by two nested convex walls, wherein the slot extends across a wall of the at least two walls that forms a convex outer wall of the cavity.

4. An antenna as claimed in claim 3, wherein each of two nested convex walls is formed of two or three planar walls.

5. A cavity backed slot antenna comprising:
at least two internal volume defining walls that define an internal volume; and
at least two further walls that are located opposite to the internal volume defining walls across the cavity and that project into the internal volume so that an outer surface created by the at least two further walls is located such that at least part of the internal volume is at an outside of the outer walls;
wherein the at least two internal volume defining walls comprise a resonant slot.

6. An antenna as claimed in claim 5, wherein the at least two internal volume defining walls form a convex arrangement and the at least two further walls form a concave arrangement nested within the convex arrangement.

7. (canceled)

8. An antenna according to claim 5, wherein the slot comprises an elongated section with one or more closed ended slots extending from one or both sides thereof.

9. An antenna according to claim 1, wherein said slot comprises a first slot resonant at a first frequency and a second slot resonant at a second frequency, wherein the first and second frequencies are different.

10. An antenna according to claim 9, wherein the first and second frequencies have bandwidth that overlap so that the input reflection loss of the antenna between the two frequencies does not rise above −10 dB.

11. An antenna according to claim 5, wherein the antenna is shaped to accommodate a corner or an edge of an underlying structure, such as an implant.

12. An implant for use in a human or animal body comprising an antenna according to claim 1.

13. A non-transient data storage device storing information for use by a 3D printer, the information, when used by the 3D printer causing the 3D printer to print an antenna according to claim 1.

14. A storage device according to claim 13, wherein the information defines the geometry of the antenna.

15. A storage device according to claim 13, wherein the information comprises commands for execution by the 3D printer, wherein said commands, when executed, cause the 3D printer to print the antenna.

16. A method of forming a cavity backed slot antenna comprising:
defining an internal volume by providing at least two internal volume defining walls;
providing, within the internal volume at least two further walls that are located opposite to the respective internal volume defining walls across the cavity and that project into the internal volume so that an outer surface created by the at least two further walls is located such that at least part of the internal volume is at an outside of the outer walls; and
providing a resonant slot in the at least two internal volume defining walls comprise a resonant slot.

17. An antenna according to claim 5, wherein said slot comprises a first slot resonant at a first frequency and a second slot resonant at a second frequency, wherein the first and second frequencies are different.

18. An antenna according to claim 10, wherein the first and second frequencies have bandwidth that overlap so that the input reflection loss of the antenna between the two frequencies does not rise above −10 dB.

19. An antenna according to claim 1, wherein the antenna is shaped to accommodate a corner or an edge of an underlying structure, such as an implant.

20. An implant for use in a human or animal body comprising an antenna according to claim 5.

21. A non-transient data storage device storing information for use by a 3D printer, the information, when used by the 3D printer causing the 3D printer to print an antenna according to claim 5.
